(19) United States
(12) Patent Application Publication
(10) Pub. No.: US 2007/0143324 A1
(43) Pub. Date: Jun. 21, 2007

(54) Graphical user interface icon for documents with status indicator

(75) Inventor: Andre Eichhorst, Ladenburg (DE)

Correspondence Address: KENYON & KENYON LLP, 1500 K STREET N.W., WASHINGTON, DC, 20005, US

(73) Assignee: SAP AG

(21) Appl. No.: 11/304,686

(22) Filed: Dec. 16, 2005

(51) Int. Cl. G06F 7/00

(52) U.S. Cl. 707/101

(57) ABSTRACT

A user interface for a computer system provides an icon view of a workspace in which the appearance of individual icons therein reflect real time changes in the status of the objects they represent. When a computer is instructed to display an icon view of a workspace, the computer may determine the status of the objects within the workspace to determined, for example, whether they are locked. When rendering a display representing the workspace, the computer may use icons that represent not only the object's type but also its status within the network. Other embodiments provide for display of further object attributes in response to user command, for example, during a ‘mouse over’ in which the operator places a pointer over an icon.

### BACKGROUND OF THE INVENTION

The present invention relates to a status indicator for document icons displayed from a file system view.

Modern computer systems employ complicated user interfaces to display various computer resources. Such user interfaces often are designed to convey as much information as possible to relieve computer operators from having to navigate among multi-level command structures to reach and display desired information. While such user interfaces often display a robust set of information, they often contribute to excess clutter within a rendered display. The user interface might be designed to display all information about all displayed records while users often are concerned only about discrete items of information from the records.

Such concerns impair the utility of the displays of file managers. File managers are the computer applications that permit operators to browse among a computer's file structure and review items stored therein. Such file managers typically have view controls that govern the format in which items are displayed. They may be displayed as icons, whether they be as “thumbnails,” “tiles” or traditional icons. They also may be displayed in a list format, with only the filename or with a detailed view that also displays metadata such as the object's size, save date, etc. Such presentation of document data, however, does not display information that may be most pertinent to the user's needs, such as whether the document is available for use, whether the document is formal work product or an ongoing draft, and the like. Accordingly, there is a need in the art for a graphical user interface that presents document information in an uncluttered fashion and still provides status information in a manner that is most pertinent to operator's needs.

### BRIEF DESCRIPTION OF THE DRAWINGS

FIG. 1 is a simplified functional diagram of a control architecture for a computer.

FIG. 2 illustrates icons according to an embodiment of the present invention.

FIG. 3 illustrates a pop up window according to an embodiment of the present invention.

FIG. 4 is a flow diagram according to an embodiment of the present invention.

FIG. 5 is a properties record of a document icon according to an embodiment of the present invention.

### DETAILED DESCRIPTION

Embodiments of the present invention provide a user interface for a computer system that provides an icon view of a workspace in which the appearance of individual icons therein reflect real time changes in the status of the objects they represent. When a computer is instructed to display an icon view of a workspace, the computer may determine the status of the objects within the workspace to determined, for example, whether they are locked. When rendering a display representing the workspace, the computer may use icons that represent not only the object's type but also its status within the network. Other embodiments provide for display of further object attributes in response to user command, for example, during a ‘mouse over’ in which the operator places a pointer over an icon.

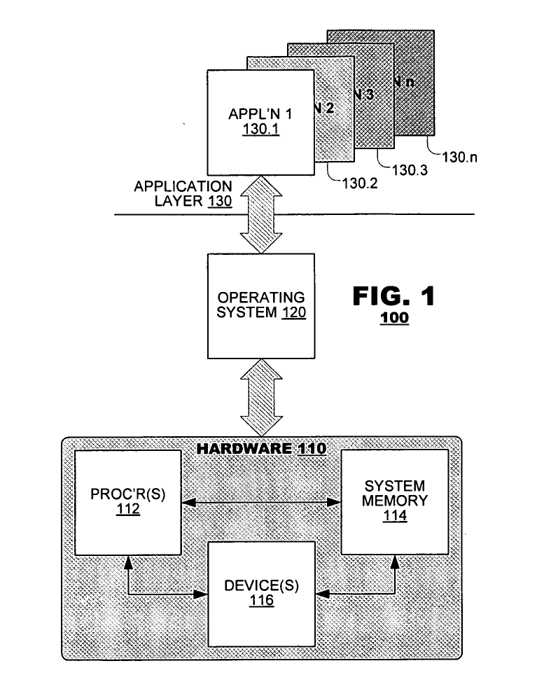

FIG. 1 is a simplified diagram of a control architecture for a computer 100. As illustrated the control architecture includes several layers of control including a hardware layer 110, an operating system layer 120 and an application layer 130. The hardware layer 110 is populated by several physical devices which constitute the computer system itself. The hardware layer 110 may include processor(s) 112, system memory 114 and I/O device(s) 116 such as pointers, keyboards and displays (not shown separately). The memory system 114 may include various electrical, magnetic and optical storage systems. Although the number and type of processors, memory and devices may vary from device to device, such differences are immaterial to the present discussion unless noted expressly herein.

The control architecture 100 also may include an operating system 120 which controls operation of devices within the hardware layer 110. The operating system 120 may include program instructions that can be executed by the processor(s) and device(s) and may include device drivers and other functional components that facilitate interaction between the components of the hardware layer. For example, the operating system may define a file system within the memory system for storage of user work product in the ordinary course of the computer's operation. The Microsoft Windows brand operating system and Unix Linux operating systems are well known types of operating systems for personal computers. The PalmOne operating system from Palm, Inc. is a well known operating system for portable digital assistant devices. Other vendors may offer operating systems for these and other computing devices.

The control architecture 100 also may include a layer 130 for applications. The application layer may include computer programs to permit the computer 100 to execute a word processing program, a spreadsheet program, a file manager, a browser or a video game. The application is executed by the hardware components via the operating system.

During execution of an application, the application and operating system cooperatively display various user interfaces to facilitate user interaction with the computer 100. For example, they may cause the computer to display icons representing various user work product, such as word processing documents, spreadsheet documents, graphics drawings, CAD drawings, presentations, data files and the like (collectively, “documents”). Operators may point and click upon icons, for example, to open a corresponding application and open the document. In this regard, the architecture and operation of computer control is well known.

Embodiments of the present invention introduce an icon management system to display status of various documents stored by the computer's file system. The icon management system may be integrated into a file manager application or any other application (e.g., a browser) that permits an operator to navigate a display items within a computer's file system. Herein, such applications are referenced collectively as “file managers.” The file system may correspond to the computer's own local storage, to resources of an integrated network or to resources extended to the computer via services provided by a wide area network such as the Internet.

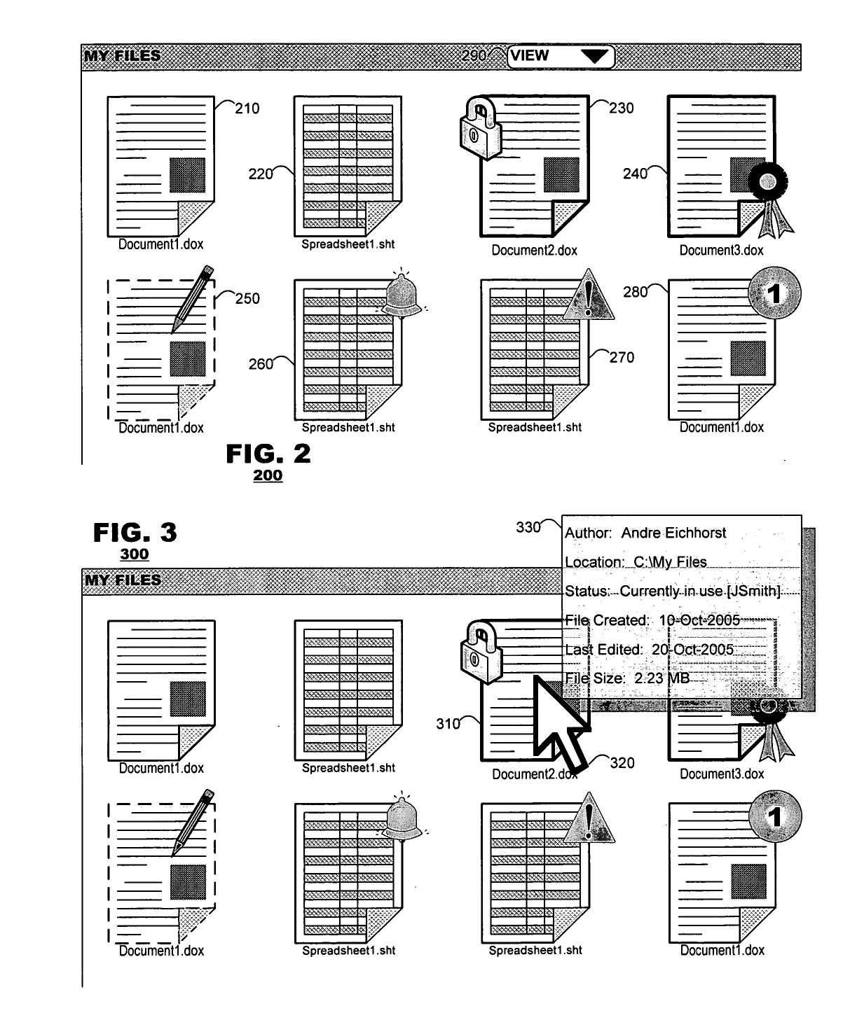

FIG. 2 illustrates a view 200 of a workspace according to an embodiment of the present invention, in which document icons are displayed with corresponding status information. FIG. 2 illustrates eight icons 210-280, which represent documents stored in a workspace called “My Files.” The workspace may represent the storage location within a hierarchy of a computer file system or a network file system. Alternatively, the workspace may represent a virtual storage space maintained by a network, without basis in physical storage. For the purposes of the present invention, it is sufficient to note that the workspace represents a network location where one or more users may create, modify and store work product.

In the example of FIG. 2, icons 210 and 220 represent a word processing document and spreadsheet document respectively. The icons 210 and 220 have different representations to illustrate the type of document and, perhaps, an application to which the document relates. In this regard, the user interface of a file explorer is well known.

In one embodiment, the file explorer may display icons that are augmented to illustrate when the document is opened an in use by another network operator. Icon 230 illustrates a word processing document having a lock integrated with the default icon to illustrate that the icon is locked from use.

In another embodiment, the file explorer may display icons that are augmented to differentiate between documents that are draft documents and documents that are formal work product of the organization. Icon 240, for example, illustrates an icon for a word processing document in which the default icon also includes a ribbon superimposed over it to illustrate that the document represented thereby is a formal document. Icon 250, by contrast, might be used to represent a document that is a draft. It illustrates the default icon for a word processing document in which the borders of the icon are illustrated in phantom lines and for which a pencil is superimposed to convey an impression that the corresponding document is a draft.

In a further embodiment, the file explorer may display icons that are augmented to identify issues that have been flagged by the documents' authors. Icons 260 and 270 are illustrated as having alarm symbols or warning symbols superimposed over default icon representation, by way of example.

In yet another embodiment, the file explorer may display icons that are augmented to illustrate relative priorities among documents. For example, icon 280 is illustrated as a default icon with a balloon superimposed over it to represent a priority 1 document. Icons for other documents (not shown) may include other numeric representation to identify different priority levels assigned to those documents. Additionally, the priority levels may be color-coded for easy review by operators. In this manner, the icons are suitable for quick review and assessment by an operator.

In a further embodiment, the file explorer may display icons that are augmented to identify documents that have been read or are unread by specific network operators. When an operator opens a document for review or revision, metadata associated with the icon may be supplemented to indicate that the network operator has accessed the document. The corresponding document icon (not shown) may be modified to demonstrate that the document has been read.

Although FIG. 2 illustrates various examples of document status identifiers that may be used in a file explorer, there is no requirement under the principles of the present invention that all variations be used concurrently in a rendered workspace view. As indicated, a display that presents too many data elements in haphazard fashion can decrease the user experience because it might contribute to clutter on a rendered display. In such an embodiment, the file explorer may include a control 290 that permits an operator to make a mode selection that determines which of the various augmentation schemes will be active.

FIG. 3 illustrates the workspace of FIG. 2 according to another embodiment of the present invention. In this view 300, additional document properties may become visible when a mouse over event occurs with respect to an augmented icon 310. Generally, a “mouse over” occurs when an operator brings a cursor 320 to a control element such as a button, a pull down menu or an icon using a pointing device and causes the icon to remain over the control element for some specified period of time. In the context of the present invention, when a mouse over occurs with respect to an augmented icon 310, the file explorer causes additional document properties to be displayed in a pop up window 330. The pop up window may display general document properties (e.g., file size, date created, etc.) and document properties that are specific to the status indicator represented by the icon. For example, for a locked document, the pop up window 330 may identify a network user that has opened the document.

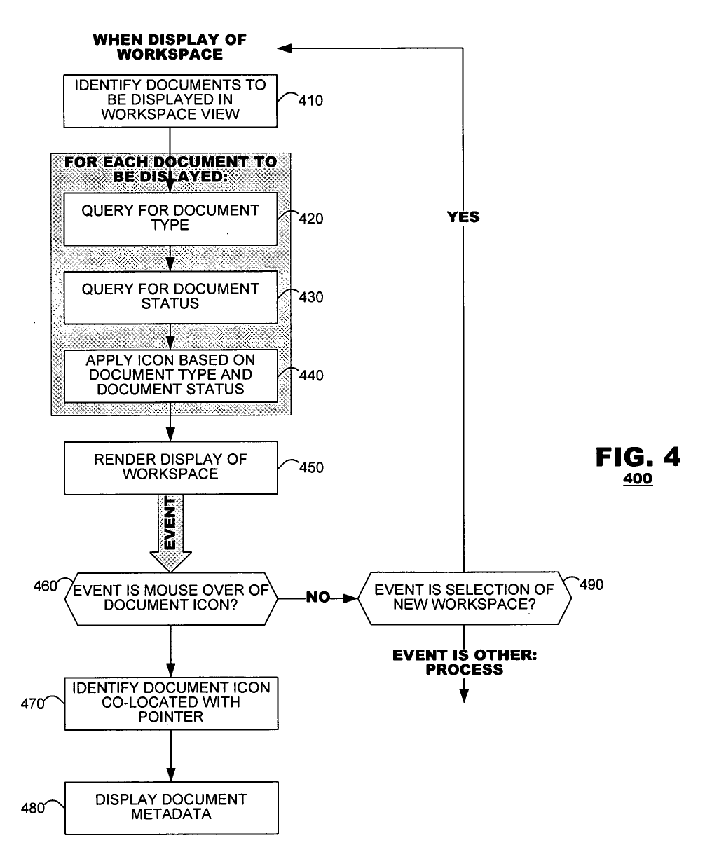

FIG. 4 is a flow diagram illustrating a method 400 according to an embodiment of the present invention. The method 400 may be invoked when a computer determines to display a workspace in the computer system. The method identifies which documents are to be displayed because they are stored in the workspace being viewed (box 410). For each document identified, the method may determine the document's type (box 420). The method also may determine the document's status (box 430) and assign an icon to the document that reflects both the document's type and the documents status (box 440). Once icon types are assigned for all objects in the workspace, the method 400 may render a display of the workspace (box 450). At this point, the method 400 may conclude.

The method 400 may capture subsequent user interaction with the rendered display as an “event.” In an embodiment, the method may determine whether the event is a mouse over of a document icon rendered in the display (box 460). If so, the method may identify the document icon co-located with the cursor (box 470) and display document metadata in a new window of the display (box 480). If the event is a selection of a new workspace for display (box 490), the method 400 may repeat itself with respect to the new workspace. Of course, other commands entered with respect to displayed objects, such as opening, copying or printing a selected document, may be acted upon as appropriate to the respective commands.

The method also may repeat itself whenever the workspace display is to be refreshed, in response either to an express command from an operator or when triggered by some member of the control architecture. Thus, the system may provide essentially a real time display of a document's status.

The method of FIG. 4 may be performed cooperatively with other processes that are conventional to file managers. For example, file managers typically render and display icons that represent network resources (printers, fax machines and network settings) and applications. Various elements of a network file system may stored documents intermixed with other network objects. In rendering icon displays for documents, the method 400 also permits icons for other network objects to be represented as is appropriate for such objects.

Conventionally, operating systems maintain metadata regarding each object in a file system. For documents, for example, conventional operating systems maintain data regarding dates of creation and modification, the location of the document within the file system and the document's size. Some metadata may be supplied to the operating system by the application through which the documents are created. The foregoing embodiments of the present invention cooperate with the connectivity resident in existing operating system and application to display such metadata when provided.

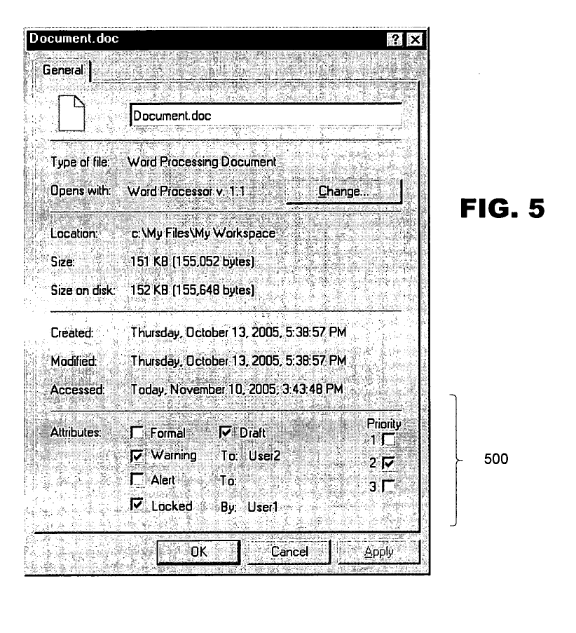

FIG. 5 illustrates an exemplary properties record 500 according to an embodiment of the present invention. The properties record displays metadata maintained by the operating system and displayable to users upon a command entered via the file manager application. According to an embodiment, various properties attributes may be maintained by the operating system to identify, for example, whether a document is a formal document or a draft, whether warnings or alerts have been flagged for the document and identifying a network operator to whom the warning or alert is addressed, and whether the document is locked because it is in use by another computer user and, optionally, by whom. The properties record also illustrates any selected priority that may have been assigned to the document. When selecting icons for use to display status, the application may query the operating system to determine which status information is appropriate for the display mode and, responsive to information returned therefrom, select an icon for display.

The foregoing description has presented operation of the present invention in the context of a file manager displaying icons of a local file space, for example, a file space located on a local drive. Conventionally, personal and laptop computers often are used as terminals within a larger network system in which resources from other computers and servers are available to them. Accordingly, operators often use a file manager on one computer to browse through file systems of remote servers or other computers. Embodiments of the present invention are applicable to such network environments as well. Thus, the foregoing embodiments find ready application anywhere a file manager is commanded to display documents of a workspace in icon form.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A user interface method in a computer system, comprising:
when contents of a workspace are to be displayed, identifying a document stored in the workspace,
identifying an attribute status condition of the document from metadata associated with the document,
if the document's attribute status is a first value, displaying the document using a default icon,
if the document's attribute status is a second value, displaying to document using the default icon augmented with a status identifier.

2. The method of claim 1, wherein the attribute status identifies whether the document is locked against use.

3. The method of claim 1, wherein the attribute status identifies whether the document has an alert associated therewith.

4. The method of claim 1, wherein the attribute status identifies the document's priority value.

5. The method of claim 1, wherein the attribute status identifies the document status as either formal work product or a draft.

6. The method of claim 1, wherein the attribute status identifies whether the document has been read by a specified network user.

7. The method of claim 1, further comprising displaying additional metadata of an icon in a pop up window in response to user interactivity with respect to the icon.

8. A user interface method in a computer system, comprising:
when contents of a workspace are to be displayed, determining a status view to be used during the display,
for all documents stored within the workspace, determining from metadata associated with the document, whether a status attribute corresponding to the status view has been enabled,
assigning default icons to the documents for which the status attribute are not enabled according to the documents' respective types,
assigning augmented icons to the documents for which the status attribute is enabled according to the documents' respective types and the status attribute, and
rendering a display of the workspace using the assigned icons.

9. The method of claim 8, wherein the status attribute identifies whether the document is locked against use,

10. The method of claim 8, wherein the status attribute identifies whether the document has an alert associated therewith.

11. The method of claim 8, wherein the status attribute identifies the document's priority value.

12. The method of claim 8, wherein the status attribute identifies the document status as either formal work product or a draft.

13. The method of claim 8, wherein the attribute status identifies whether the document has been read by a specified network user.

14. The method of claim 8, further comprising displaying additional metadata of an icon in a pop up window in response to user interactivity with respect to the icon.

15. A computer system, comprising:
a processor,
a memory system in communication with the processor, the memory system including a file system for storage of documents,
a display
an operating system to be executed by the processor, and
a file manager application that, when executed by the processor:
identifies a document stored in a workspace of the file system to be displayed,
identifies an attribute status condition of a document in the workspace from metadata associated with the document,
displays the document using a default icon if the document's attribute status is a first condition, and
displays the document using the default icon augmented with a status identifier, if the attribute status is a second condition.

16. The system of claim 15, wherein the attribute status identifies whether the document is locked against use,

17. The system of claim 15, wherein the attribute status identifies whether the document has an alert associated therewith.

18. The system of claim 15, wherein the attribute status identifies the document's priority value.

19. The system of claim 15, wherein the attribute status identifies the document status as either formal work product or a draft.

20. The system of claim 15, wherein the attribute status identifies whether the document has been read by a specified network user.

21. The system of claim 15, wherein the file manager application displays additional metadata of an icon in a pop up window in response to user interactivity with respect to the icon.
